(19) United States
(12) Patent Application Publication
(10) Pub. No.: US 2003/0010940 A1
(43) Pub. Date: Jan. 16, 2003

(54) Target tracking system for an X-Y table having an optical beam

(76) Inventors: Phillip V. Mitchell, Laguna Niguel, CA (US); William A. Culpi, Lake Forest, CA (US)

Correspondence Address: IRELL & MANELLA LLP, 840 NEWPORT CENTER DRIVE, SUITE 400, NEWPORT BEACH, CA, 92660, US

(21) Appl. No.: 09/907,242

(22) Filed: Jul. 16, 2001

(51) Int. Cl. G01N 21/86

(52) U.S. Cl. 250/559.29

(57) ABSTRACT

A system that can track a beam of light onto a target moving on a table. The system may include a table that moves the target and a light source which emits a beam of light that is directed onto the target. The system may further have a beam steering element that is in the optical path to re-direct the beam and track the movement of the target. In one embodiment the system includes a controller which determines an error signal from a desired position of the target and an actual position of the target. The error position is transmitted to the beam steering element to re-direct the beam and track the moving the target.

### BACKGROUND OF THE INVENTION

1. Field of the Invention

The present invention relates to an apparatus and method for maintaining the position of a light beam on a moving target in a manufacturing process.

2. Background Information

Light beams are sometimes used to perform work or inspection of a manufactured part. For example, laser beams are commonly used to drill via holes in printed circuit boards (PCBs). The via holes can then be inspected by an optical system. The via holes are typically located at various locations across the PCB. The PCB is mounted to an x-y table that can move the board to allow drilling at the different via locations.

The PCB is typically moved in step functions. That is, the x-y table moves the PCB to a desired position and the beam is then directed onto the board to drill a set of via holes. Because of vibration in the system the PCB may move back and forth in an oscillating manner even when the table has “stopped” at the desired position. The system typically allows the table to settle before drilling the set of via holes. After drilling, the table is again actuated and another set of via holes are drilled after awaiting a predetermined settling time. This process is repeated across the surface of the PCB.

Waiting for the table to settle increases the amount of time required to drill all of the via holes in the PCB. Settling time therefore increases the time and associated cost to manufacture a PCB. Consequently, it is desirable to reduce or eliminate the settle time of the table.

There have been developed systems that minimize the amount of ringing induced by moving the table. These systems typically operate in accordance with an algorithm which generates a predetermined position, velocity and/or acceleration curve for the table. These curves have predetermined profiles which attempt to minimize the amount ringing and corresponding settling time associated with moving the table from one position to another position. Even with the table motion profile approach the mass and other factors limit the speed of the table.

### BRIEF SUMMARY OF THE INVENTION

A system with a table which moves a target, and a beam steering element that re-directs a beam of light to track the movement of the target.

### BRIEF DESCRIPTION OF THE DRAWINGS

FIG. 1 is a schematic of an embodiment of a system with a beam steering element that tracks a beam of light onto a moving target;

FIG. 2 is a schematic of a control system of the system shown in FIG. 1;

FIG. 3 is a schematic of an alternate embodiment of the system;

FIG. 4 is a schematic of a control system for the system shown in FIG. 3;

FIG. 5 is a schematic of an alternate embodiment of the system.

### DETAILED DESCRIPTION OF THE PREFERRED EMBODIMENT

Disclosed is a system that can track a beam of light onto a target moving on a table. The system may include a table that moves the target, and a light source which emits a beam of light that is directed onto the target. The system may further have a beam steering element that is in the optical path to re-direct the beam and track the movement of the target. In one embodiment the system includes a controller which determines an error signal from a desired position of the target and an actual position of the target. The error signal is transmitted to the beam steering element to re-direct the beam and track the moving target.

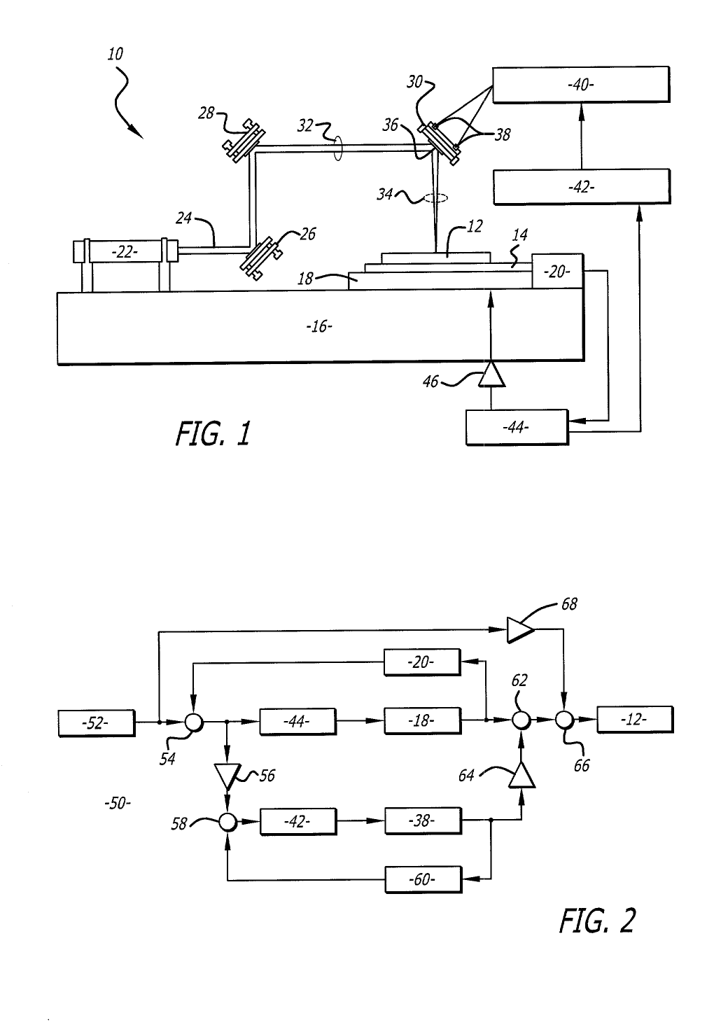

Referring to the drawings more particularly by reference numbers, FIG. 1 shows an embodiment of a system 10 for working and/or inspecting a target 12. The target 12 is typically a part that is being manufactured. By way of example and without limiting the scope of the invention, the target 12 may be a printed circuit board.

The system 10 may include an x-y translation table 14 that is mounted to a platform 16. By way of example, the platform 16 may be a granite slab. The table 14 may have actuators 18 that can move the target 12 in both an x direction and a y direction relative to the platform 16. The table 14 may further have a position detector 20 that provides an output signal which corresponds to the actual position of the table 14 and the target 12.

The system 10 may further have a light source 22 that emits a beam of light 24. By way of example, the light source 22 may be a laser that generates a laser beam. The system 10 may further have a first mirror 26 and a second mirror 28 to direct the light to a beam steering element 30. The beam steering element 30 directs the light 22 onto the target 12. The light beam 22 may be focused onto the target 12 with a lens 32 located between the second mirror 28 and the beam steering element 30. Alternatively, the system 10 may include a lens 34 that together with the beam steering element 30 both focus and scan the beam 22 across the target 12 as a beam scanning head.

The beam steering element 30 may include a mirror 36 that is tilted by actuators 38. The actuators 38 may be driven by actuator driver circuits 40 to tilt the mirror 36 about two perpendicular x and y axes. Tilting the mirror 36 will re-direct the light beam 22 to a different location on the target 12. The actuators 38 may be voice coil motors which can move the mirror 36 relatively quickly. Additionally, voice coil motor based actuators 38 can provide a relatively broad field of view for the beam steering element 30. Mirrors tilted by voice coil motors are sometimes referred to as fast steering mirrors (FSMs). Although voice coil motors are described, it is to be understood that the actuators 38 may be of another type such as piezoelectric.

The actuator driver circuits 40 and position detector 20 are coupled to a beam steering element controller 42. The position detector 20 is also connected to a table controller 44. The table controller 44 is coupled to the table actuators 18 by a driver circuit 46.

FIG. 2 shows a control circuit 50 for the system 10. The system 50 includes a command generator 52 which issues an output signal to move the table to a desired position. The generator 52 may include software and/or firmware to provide instructions for the desired table position. The desired position signal is combined with an actual position signal from the position detector 20 at a summing junction 54. The difference between the desired and actual position signals is an error signal that is provided to the table controller 44. The controller 44 processes the error signal to generate a control signal which controls the actuators 18 to move the table.

The error signal is also provided to the beam steering element controller 42 through scaling element 56 and summing junction 58. The controller 42 processes the error signal to generate a control signal that controls the beam steering element actuators 38 and tilts the mirror. The beam steering element 30 may include an internal position detector 60 that provides feedback on the actual position of the mirror through summing junction 58.

The actual mirror position is summed with the actual table position at summing junction 62. The control system 50 may include a gain element 64 to increase the amplitude of the actual mirror position signal. The output of summing junction 62 is summed with the desired position signal at summing junction 66. The output of summing junction 66 is a target error. The desired position signal may be scaled by scaling element 68 before be summed at summing junction 66.

In operation, the command generator 50 generates a command to move the target to a desired position. The actuators 18 then move the target to the desired position. When the target 12 is commanded to stop the table may “ring” which moves the target to an actual position that deviates from the desired position. This deviant actual position will generate an error signal that is processed by the controller 42 to tilt the mirror and move the light in accordance with the movement of the target. In accordance with the control system 50, the beam steering element causes the beam to oscillate with the table so that the beam is at the same spot on the target. The beam thus tracks the movement of the target.

Instead of trying to minimize or control the vibration of the table the system 10 utilizes the low mass of the mirror to move the light beam with the table. The speed of the beam steering element allows the table to move the target very quickly. Additionally, because the light beam tracks the movement of the table the system does not have to wait a settling time to inspect or perform work on the target. This increases manufacturing throughput and reduces the cost of producing the target part.

By way of example, the table may move a PCB target to allow the light beam to ablate a via hole in the board. Instead of waiting for a settling time, the beam steering element constantly re-directs the light beam to insure that the beam is at the same location of the PCB during the drilling process. This approach increases both the accuracy and speed in drilling the holes. Alternatively, the table may constantly move the board target wherein the light beam is intermittently directed onto the PCB to inspect or perform work on the board.

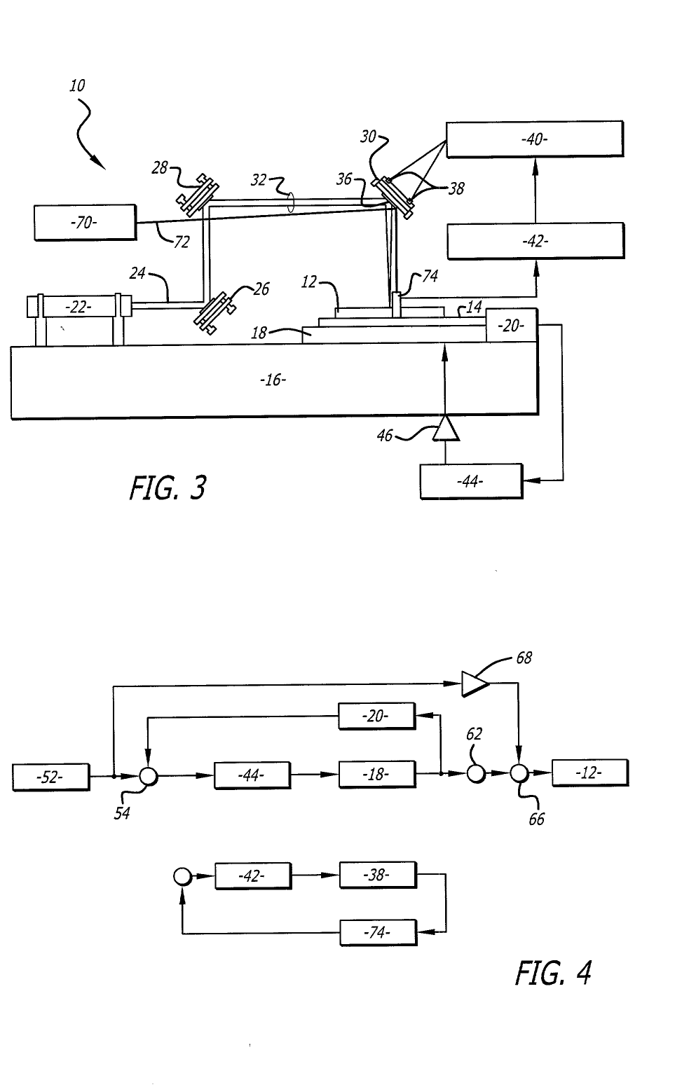

FIG. 3 shows an alternate embodiment of a system 10′ which has a second light source 70 that emits a tracking light beam 72. The tracking light beam 72 is directed onto a photo-detector 74 by the beam steering element 30 and mirrors 26 and 28. The photo-detector 74 is coupled to the table 12 so that any oscillating movement of the target is translated to the detector 74.

FIG. 3 shows a control system 50 for the embodiment shown in FIG. 2. The control loop for the mirror is de-coupled from the control loop for the table. Any oscillating movement of the table will cause a corresponding oscillating movement of the photo-detector 74. Movement of the detector 74 will generate an error signal at the input of the controller 42. The controller 42 will process the error signal to tilt the mirror so that the light beam 22 tracks the movement of the table. This system 50′ does not utilize the error signal generated by the table control loop, although the system 50′ could be configured to receive input from the table to obtain gross position information of the target.

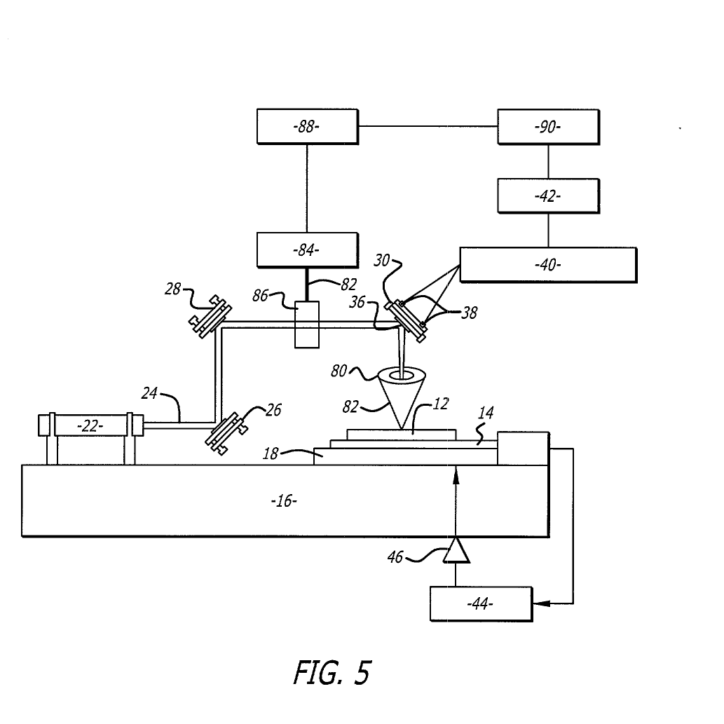

FIG. 5 shows another embodiment of the system 10″. This system 10″ includes an inspection light source 80 to allow inspection of the target. The light source 80 may be a ring light or other means for illuminating the target. The light 82 from source 80 is reflected from the target and directed into a camera 84 by the beam steering element 30 and a beam splitter 86. The camera 84 may be coupled to a monitor 88 to allow visual inspection of the target 12. By way of example, the camera 84 may be a charged coupled device (“CCD”).

The camera 84 may be coupled to a computer 90 which performs digital signal processing of the camera output signals. The computer 90 may include a pattern recognition software/firmware routine to determine defects on the target. Additionally, the computer 90 can determine undesired movement of the target and provide output signals to the driver circuit 40 to tilt the mirror 36 so that light 82 tracks the target movement. The system may also include a light beam 22 to perform work on the target. The beam steering element 30 could also re-direct the working beam 22 to track any undesirable movement of the target.

While certain exemplary embodiments have been described and shown in the accompanying drawings, it is to be understood that such embodiments are merely illustrative of and not restrictive on the broad invention, and that this invention not be limited to the specific constructions and arrangements shown and described, since various other modifications may occur to those ordinarily skilled in the art.

For example, the embodiments shown in both FIGS. 1 and 3 may include an additional light source and camera to allow inspection of the target. The light source and camera may be in addition to, or in lieu of, the light source 22. Additionally, the system shown in FIG. 5 may include the tracking beam shown in FIG. 3 and include a quad light detector.

What is claimed is:

1. A system that supports a target, comprising:
a table coupled to the target;
a table actuator coupled to said table, said table actuator being adapted to move the target;
a light source that emits a beam of light that is directed onto the target;
a beam steering element that re-directs the beam of light;
a controller to control said beam steering element so that the beam of light tracks the movement of the target.

2. The system of claim 1, further comprising a position sensor that senses a position of said table and provides an actual position signal to said controller.

3. The system of claim 2, wherein said controller computes an error signal as a difference between a desired position and the actual position of said table, said error signal being coupled to said beam steering element.

4. The system of claim 1, further comprising an optical detector coupled to said table, and a tracking light source that emits a tracking beam of light that is reflected from said beam steering element onto said optical detector, said optical detector being coupled to said controller.

5. The system of claim 4, wherein said controller computes an error signal as a difference between a desired position and the actual position of said table provided by said optical detector, said error signal being coupled to said beam steering element.

6. The system of claim 1, further comprising a camera that is coupled to said controller and detects at least a portion of the beam of light.

7. The system of claim 1, wherein said beam steering element includes a mirror.

8. The system of claim 1, wherein said light source includes a laser.

9. The system of claim 1, further comprising a scanning head assembly located between said beam steering element and said table.

10. The system of claim 1, wherein said beam steering element includes a voice coil motor actuator.

11. A system that supports a target, comprising:
table means for moving the target;
light source means for generating a beam of light that is directed onto the target;
beam steering means for re-directing the beam of light;
controller means for controlling said beam steering means so that the beam of light tracks the movement of the target.

12. The system of claim 11, wherein said table means includes a position sensor that senses a position of said table means and provides an actual position signal to said controller means.

13. The system of claim 12, wherein said controller means computes an error signal as a difference between a desired position and the actual position of said table means, said error signal being coupled to said beam steering means.

14. The system of claim 11, further comprising an optical detector coupled to said table means, and tracking light source means for generating a tracking beam of light that is reflected from said beam steering means onto said optical detector, said optical detector being coupled to said controller means.

15. The system of claim 14, wherein said controller means computes an error signal as a difference between a desired position and the actual position of said table means provided by said optical detector, said error signal being coupled to said beam steering means.

16. The system of claim 11, further comprising a camera that is coupled to said controller means and detects at least a portion of the beam of light.

17. The system of claim 11, wherein said beam steering means includes a mirror.

18. The system of claim 11, wherein said light source means includes a laser.

19. The system of claim 11, further comprising a scanning head assembly located between said beam steering means and said table means.

20. The system of claim 11, wherein said beam steering means includes a voice coil motor activator.

21. A system that supports a target, comprising:
a table coupled to the target;
a table actuator coupled to said table, said table actuator being adapted to move the target;
a position sensor that provides an output signal that corresponds to an actual position of the said table;
a light source that emits a beam of light that is directed onto the target;
beam steering element that re-directs the beam of light;
a controller that is coupled to said beam steering element and determines an error signal between a desired position of said table and the actual position of said table to generate an error signal used to re-direct the beam of light.

22. The system of claim 21, wherein said beam steering element includes a mirror.

23. The system of claim 21, wherein said light source includes a laser.

24. The system of claim 21, further comprising a scanning head assembly located between said beam steering element and said table.

25. The system of claim 21, wherein said beam steering element includes a voice coil motor actuator.

26. A system that supports a target, comprising:
table means for moving the target;
position sensor means for providing an output signal that corresponds to an actual position of said table means;
light source means for generating a beam of light that is directed onto the target;
beam steering means for re-directing the beam of light;
controller means for determining an error signal between a desired position of said table means and the actual position of said table means to generate an error signal used to re-direct the beam of light.

27. The system of claim 26, wherein said beam steering means includes a mirror.

28. The system of claim 26, wherein said light source means includes a laser.

29. The system of claim 26, further comprising a scanning head assembly located between said beam steering means and said table means.

30. The system of claim 26, wherein said beam steering means includes a voice coil motor actuator.

31. A method for directing a light beam onto a target supported by a table, comprising:
coupling a target to a table;
directing a beam of light onto the target;
moving the table and the target; and,
re-directing the beam of light to track the movement of the target.

32. The method of claim 31, wherein the beam of light performs work on the target.

33. The method of claim 31, further comprising directing another beam of light onto the target.

34. The method of claim 33, further comprising detecting the other beam of light with an optical detector.

35. A method for tracking a target that moves on a table, comprising:
coupling the target to a table;
moving the table and the target to a desired position;
determining an actual position of the table;
directing a beam of light onto the target;
determining an error signal from the actual and desired positions of the table; and,
re-directing the beam of light in response to the error signal.

36. The method of claim 35, wherein the beam of light performs work on the target.

37. The method of claim 35, further comprising directing another beam of light onto the target.

38. The method of claim 37, further comprising detecting the other beam of light with an optical detector.
